(19) United States
(12) Patent Application Publication
(10) Pub. No.: US 2003/0071912 A1
(43) Pub. Date: Apr. 17, 2003

(54) Image pickup and printing system

(75) Inventor: Jun Minakuti, Osaka (JP)

Correspondence Address: McDERMOTT, WILL & EMERY, 600 13th Street, N.W., Washington, DC, 20005, US

(73) Assignee: Minolta Co., Ltd.

(21) Appl. No.: 10/265,710

(22) Filed: Oct. 8, 2002

(30) Foreign Application Priority Data
Oct. 12, 2001 (JP) P2001-315262

(51) Int. Cl. H04N 5/225

(52) U.S. Cl. 348/372

(57) ABSTRACT

Each of a digital camera and a printer has an auto power saving function, shifts to a power saving mode when there is no operation of the user for predetermined time, and returns to a normal mode when there is any user operation. When the digital camera returns from the power saving mode to the normal mode, a WakeUp signal is transmitted to the printer. On receipt of the WakeUp signal, the printer returns to the normal mode. Also when the printer returns to the normal mode, the WakeUp signal is transmitted to the digital camera, and the digital camera returns to the normal mode. Thus, by returning one of the devices to the normal mode, both of the devices return to the normal mode, so that the devices can be more easily handled.

This application is based on application No. 2001-315262 filed in Japan, the contents of which are hereby incorporated by reference.

### BACKGROUND OF THE INVENTION

1. Field of the Invention

The present invention relates to a technique of performing communication between a digital camera and a printer.

2. Description of the Background Art

Conventionally, there has been known an image pickup and printing system in which a digital camera and a portable small printer are connected to each other via a communication cable or the like so that an image captured by the digital camera can be printed at the site of image pickup. There have been also proposed an image pickup and printing system in which a digital camera and a printer can be integrated by a simple handling without requiring a communication cable or the like, and an image pickup and printing system in which wireless communication can be performed between a printer and a digital camera.

Since it is assumed that the digital camera and the portable printer are carried to a site of image pickup, the size of each of the digital camera and the portable printer is reduced. Consequently, the capacity of a battery is also limited, so that a function of suppressing power consumption as much as possible is provided.

One of such known functions is an auto power saving function of, when the user does not perform operation for a predetermined time, shifting to a power saving mode in which power is supplied only to minimum processing units for determining a user handling or the like and supply of power to other major processing units is stopped. Generally, the digital camera and the printer having the function return from the power saving mode to a normal mode when the user performs some handling.

However, each of the conventional digital camera and printer has an auto power saving function which is completed by itself. In order to return both of the devices to the normal mode when they are in the power saving mode, handling has to be performed independently to each of the devices, so that a complicated work accompanies.

Particularly, in the case where the digital camera and the printer are in positions apart from each other due to wireless communication or the like, the digital camera is returned to the normal mode and, after that, the user has to come to the printer to return the printer to the normal mode, so that usability is very bad.

### SUMMARY OF THE INVENTION

The present invention is directed to an image pickup and printing system comprising a digital camera and a printer as devices which can communicate with each other.

According to a present invention, each of the digital camera and the printer of the system includes: a power controller capable of switching a self device of the devices between a normal mode and a power saving mode; and a signal generator for generating a first control signal in response to a user handling of the self device and supplying the first control signal to the power controller of the self device and the power controller of the other device of the devices, and the power controller of each of the digital camera and the printer causes the self device to return from the power saving mode to the normal mode irrespective of whether the first control signal is supplied from the self device or the other device.

By handling one of the digital camera and the printer, the first control signal is supplied to the power controller of each of the devices. Consequently, both of the devices return from the power saving mode. This eliminates a need of a complicated handling of causing the devices to independently return to the normal mode so that the devices can be more easily handled.

In an aspect of the present invention, the signal generator transmits the first control signal to the other device only when an operation instructed by the user handling of the self device requires an operation of the other device.

While one of the digital camera or the printer is handled, the other device returns to the normal mode, only when an operation instructed by the user handling requires an operation of the other device. Consequently, when an operation of the other device is not required, the other device remains in the power saving mode, so that power consumption can be effectively suppressed.

In another aspect of the present invention, each of the digital camera and the printer further includes a register for registering the self device as a device to be handled in response to occurrence of the user handling of the self device, and the power controller of each of the digital camera and the printer causes the self device to shift from the normal mode to the power saving mode in response to a second control signal generated in the device to be handled.

When the second control signal is generated by the device to be handled by the user, both of the digital camera and the printer shift to the power saving mode. Thus, power consumption can be effectively suppressed. Even when the second control signal is generated in the device which is not handled, the device to be handled does not shift to the power saving mode. Consequently, a problem such that the device to be handled by the user suddenly shifts to the power saving mode in response to the shift of the device not to be handled to the power saving mode can be avoided.

The present invention is also directed to a digital camera which can communicate with a printer.

The present invention is also directed to a printer which can communicate with a digital camera.

Accordingly, an object of the present invention is to provide a technique capable of easily realizing a return from a power saving mode of both of a digital camera and a printer.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a digital camera according to a preferred embodiment;

FIG. 2 is a rear view of the digital camera;

FIG. 3 is a block diagram schematically showing a configuration of the digital camera;

FIG. 4 is a front view of a printer according to the preferred embodiment;

FIG. 5 is a rear view of the printer;

FIG. 6 is a block diagram schematically showing a configuration of the printer;

FIG. 7 is a diagram showing a main internal configuration of the printer;

FIG. 8 is a diagram showing an image pickup and printing system in the case where a digital camera and a printer are directly connected to each other so as to be integrated;

FIG. 9 is a diagram showing the details of a coupling member for physically coupling between the digital camera and the printer;

FIG. 10 is a diagram showing the image pickup and printing system in the case where the digital camera and the printer are connected to each other via a transmission cable;

FIG. 11 is a diagram showing an image pickup and printing system in the case where wireless communication is performed between the digital camera and the printer;

FIG. 12 is a flowchart showing a basic operation of the digital camera;

FIGS. 13 and 14 are flowcharts showing an image pickup process of the digital camera;

FIG. 15 is a flowchart showing a printing instructing process of the digital camera;

FIG. 16 is a flowchart showing a flash mode changing process of the digital camera;

FIG. 17 is a flowchart showing a print image number changing process of the digital camera;

FIG. 18 is a flowchart showing a printer signal process of the digital camera;

FIG. 19 is a flowchart showing a power saving mode shifting process of the digital camera;

FIG. 20 is a flowchart showing a basic operation of the printer;

FIG. 21 is a flowchart showing a camera signal process of the printer;

FIG. 22 is a flowchart showing a switching process of the printer;

FIG. 23 is a flowchart showing a power saving mode shifting process of the printer; and

FIG. 24 is a flowchart showing a printing process of the printer.

### DESCRIPTION OF THE PREFERRED EMBODIMENT

A preferred embodiment of the present invention will be described later with reference to the drawings.

1. Configuration of Digital Camera

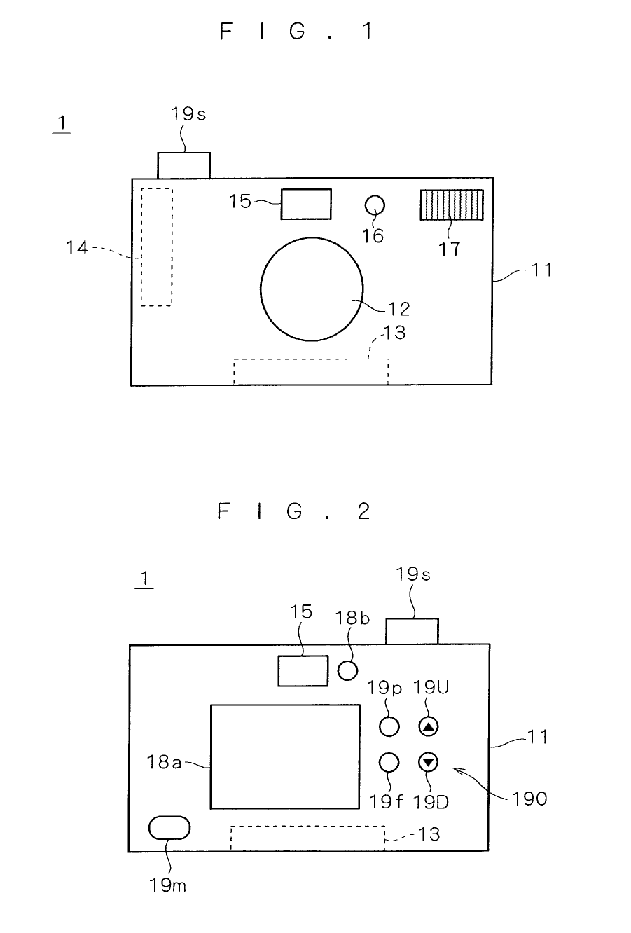

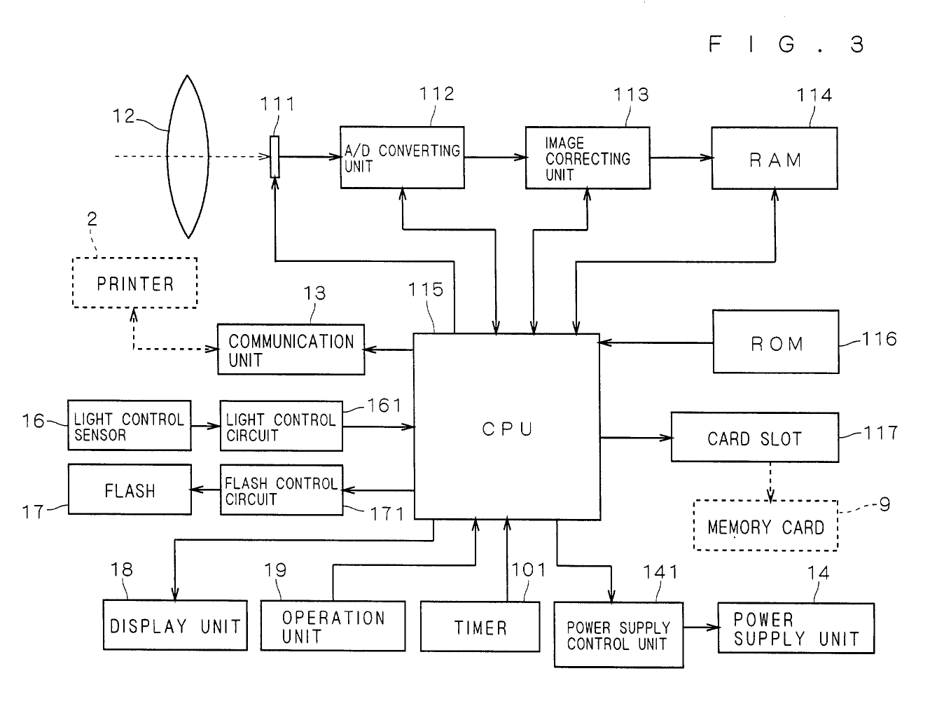

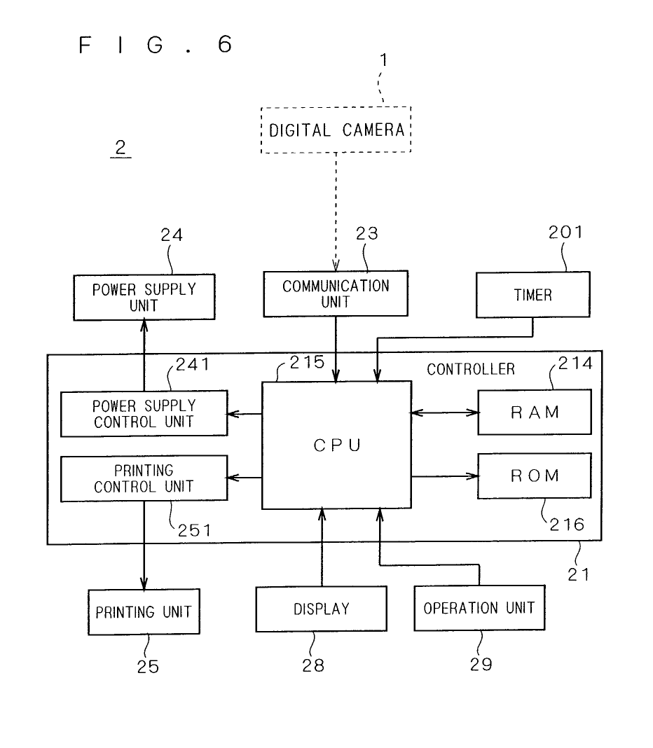

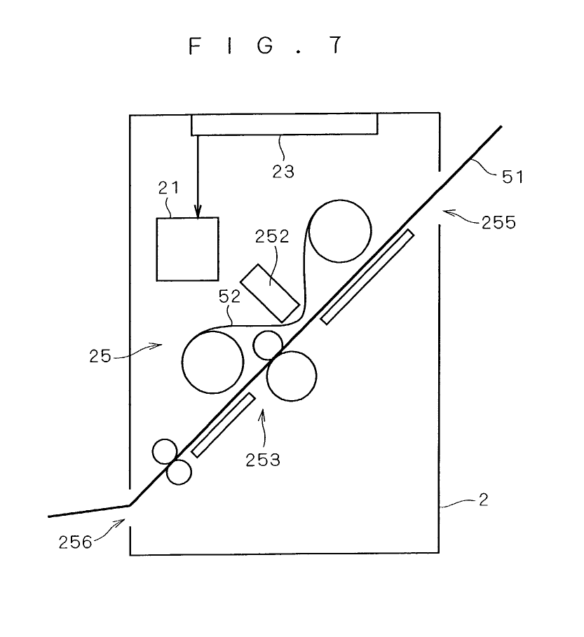

FIG. 1 is a front view of a digital camera 1 according to the preferred embodiment of the present invention. FIG. 2 is a rear view of the digital camera 1. The digital camera 1 has a function of capturing an image of a subject and transmitting the image to be printed toward a printer 2 (see FIGS. 4 and 5) which will be described later, and also an auto power saving function of shifting an operation mode to a power saving mode in which power consumption is suppressed after the digital camera 1 is not handled for a predetermined time.

The digital camera 1 has a lens system 12 in the front face of its body 11. In the front face of the body 11, a finder 15 used by the user to capture a subject, a flash 17 for illuminating the subject, and a light control sensor 16 for receiving reflected light of the flash light from the subject are provided. With respect to setting of emission of the flash 17 (hereinafter, referred to as a “flash mode”), one of a forced flash mode of forcedly making a flash, a flash inhibition mode of inhibiting flash, and an automatic flash mode of automatically determining whether a flash is made or not can be selected.

The body 11 has therein a communication unit 13 as a communication interface for performing communication with the printer 2 and a power supply unit 14 in which a general dry battery or rechargeable battery can be loaded. The digital camera 1 uses a dry batter or rechargeable battery to be loaded in the power supply unit 14 as a drive source, and power is supplied to each of units in the digital camera 1 from the power supply unit 14.

In the center of the rear face of the body 11, a liquid crystal display 18a for displaying a captured image and a menu to the user is provided. On the right side of the finder 15 in the rear face of the body 11, an indication lamp 18b taking the form of a red LED or the like for warning the user of any of various states is provided.

A shutter button 19s for accepting an image pickup start instruction from the user is provided on the top face of the body 11. A power supply switch 19m for switching the on/off state of the power supply is disposed in the lower left portion of the rear face of the body 11. A switch group 190 (a printing switch 19p, a flash mode changing switch 19f, an upward switch 19U and a downward switch 19D) for accepting a user handling is disposed on a side of the display 18a. The shutter button 19s is a two-stage switch capable of detecting a half-pressed state and a full-pressed state. The digital camera 1 in the power saving mode is returned to a normal state (hereinafter, referred to as a “normal mode”) when the shutter button 19s or one of the switch group 190 is handled.

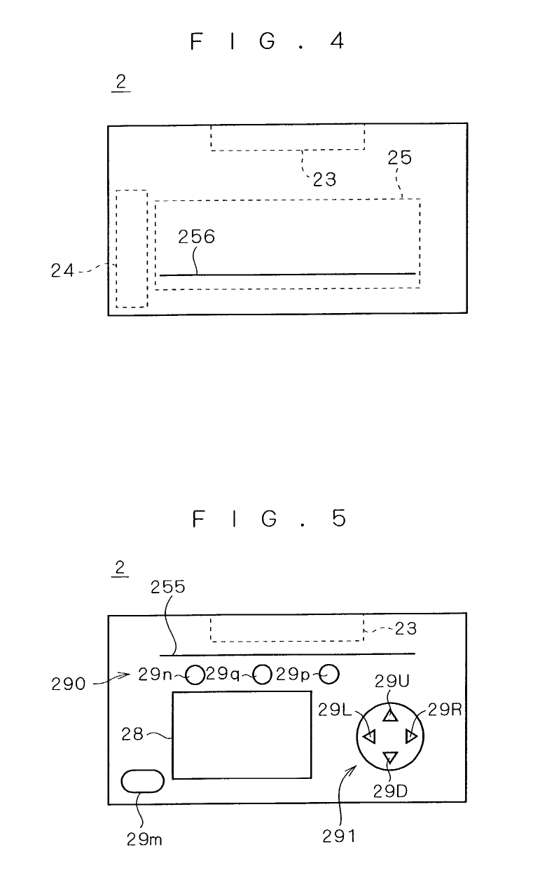

FIG. 3 is a block diagram schematically showing a configuration of the digital camera 1. In the diagram, the lens system 12, a CCD 111, an A/D converting unit 112, an image correcting unit 113, and a RAM 114 correspond to a function of capturing an image of the subject. Specifically, when the shutter button 19s is fully pressed, an image of the subject formed by the lens system 12 is captured as an image signal by the CCD 111, an image signal (hereinafter, also appropriately referred to as “image” or “image data”) from the CCD 111 is converted by the A/D converting unit 112 into a digital signal, the digital signal is subjected to predetermined processes such as white balance adjustment and γ correction by the image correcting unit 113, and the resultant is stored into the RAM 114. The image stored in the RAM 114 is stored into a detachable memory card 9 via a card slot 117.

In FIG. 3, a display unit 18 is a processing unit for displaying various images and indications to the user, such as the display 18a and the indication lamp 18b, and an operation unit 19 is a processing unit for accepting a user handling, such as the shutter button 19s, switch group 190, and power supply switch 19m. The display unit 18 and the operation unit 19 are electrically connected to a CPU 115. When the user handling is performed, a signal indicative of the kind of the user handling (switch) is inputted from the operation unit 19 to the CPU 115.

The light control sensor 16 is connected to the CPU 115 via a light control circuit 161, and the flash 17 is connected to the CPU 115 via a flash control circuit 171. The light control circuit 161 detects a flash light amount by integrating reflection light of the flash light from the subject received by the light control sensor 16. The flash control circuit 171 controls emission and stop of the flash 17.

A power supply control unit 141 for controlling the destination of power supply from the power supply unit 14 is connected to the CPU 115. The power supply control unit 141 controls so as to supply power to all of processing units of the digital camera 1 in the normal mode, and so as to supply power only to minimum processing units necessary for a determination process for returning from the power saving mode which will be described later in the power saving mode.

The communication unit 13 is also electrically connected to the CPU 115. The digital camera 1 can perform communication such as transmission of image data stored in the memory card 9 and the like and various signals to the printer 2 via the communication unit 13. Further, a timer 101 for counting time is also connected to the CPU 115.

The operation of each of the units of the digital camera 1 is controlled by the CPU 115. Concretely, the CPU 115 performs computation in accordance with a control program stored in a ROM 116, thereby realizing the operation control. The control program is stored in the ROM 116 when the digital camera 1 is manufactured. The control program may be read from the memory card 9 and stored into the ROM 116.

2. Configuration of Printer

FIG. 4 is a front view of the printer 2 according to the preferred embodiment of the present invention. FIG. 5 is a rear view of the printer 2. The printer 2 has a function of receiving image data from the digital camera 1 and printing the image data, and also has an auto power saving function of shifting to a power saving mode in which power consumption is suppressed after it is not handled for a predetermined time in a manner similar to the digital camera 1.

The printer 2 has therein a printing unit 25, and a paper ejection port 256 for ejecting a printed sheet of paper is provided in the front face of the body cover. Above the printing unit 25, a communication unit 23 as a communication interface for performing communication with the digital camera 1 is provided. On a side of the printing unit 25, a power supply unit 24 in which a general dry battery or rechargeable battery can be loaded is provided. The printer 2 uses the dry battery or rechargeable battery to be loaded in the power supply unit 24 as a drive source, and power is supplied to each of units of the printer 2 from the power supply unit 24.

In the rear face of the printer 2, a paper feed port 255 for supplying a sheet to be printed is provided. In the center of the rear face, a liquid crystal display 28 for displaying a menu to the user is provided.

A power supply switch 29m for switching the on/off state of the power supply is disposed in the lower left portion of the rear face of the printer 2. A switch group 290 (a menu switch 29n, an image request switch 29q and a printing switch 29p) for accepting a user handling is disposed above the display 28. A four-way switch 291 (an upward switch 29U, a downward switch 29D, a left-direction switch 29L and a right-direction switch 29R) is disposed on a side of the display 28. The printer 2 in the power saving mode is returned to the normal mode when one of the switch group 290 and the four-way switch 291 is handled.

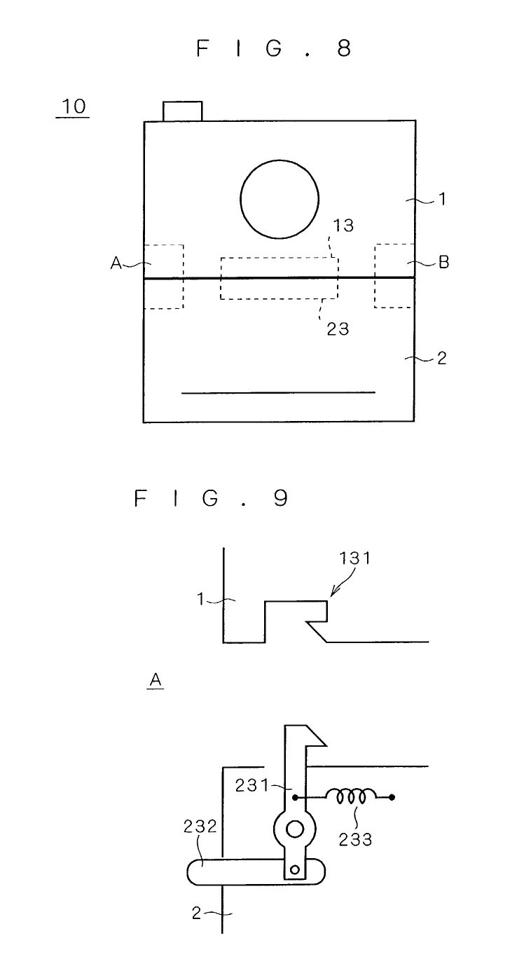

FIG. 6 is a block diagram schematically showing a configuration of the printer 2. The printer 2 has therein a controller 21 for controlling the whole device. The controller 21 has a CPU 215 as a body part, a RAM 214 serving as a work area of computation, for storing various information, and a ROM 216 for storing a control program. The operation control of each of the units of the printer 2 is realized when the CPU 215 executes computation in accordance with the control program stored in the ROM 216.

The controller 21 further includes a printing control unit 251 for controlling printing of the printing unit 25, and a power supply control unit 241 for controlling the destination of power supply from the power supply unit 24. The printing control unit 251 is connected to the printing unit 25, and the power supply control unit 241 is connected to the power supply unit 24. The power supply control unit 241 executes control so as to supply power to all of processing units in the printer 2 in the normal mode, and so as to supply power only to the minimum processing units necessary for a determination process for returning from the power saving mode which will be described later in the power saving mode.

In FIG. 6, an operation unit 29 corresponds to a processing unit for accepting user handling of the power supply switch 29m, the switch group 290, the four-way switch 291 and the like. The operation unit 29 is electrically connected to the controller 21. When the user handling is performed, a signal indicative of the kind of the user handling (switch) is inputted from the operation unit 29 to the CPU 215.

The communication unit 23 is also electrically connected to the controller 21. The printer 2 can perform communication such as reception of image data and various signals from the digital camera 1 via the communication unit 23. Further, a timer 201 for counting time and the display 28 are also connected to the controller 21.

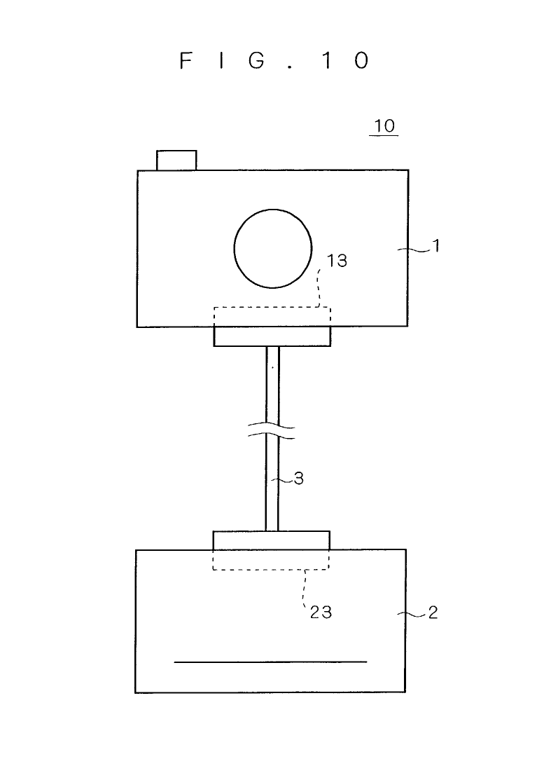

FIG. 7 is a diagram showing a main configuration of the printing unit 25 in the printer 2. The left side of FIG. 7 corresponds to the front face of the printer 2. As shown in the diagram, the printing unit 25 has a print head 252 for printing an image on a sheet 51 of paper, and a carrying mechanism 253 for carrying the sheet 51 of paper supplied from the paper feed port 255.

In the case of printing image data, the print head 252 is heated on the basis of the image data to be printed. At this time, the carrying mechanism 253 carries the sheet 51 of paper and also an ink sheet 52. By sublimating ink of the ink sheet 52, the image data is printed on the sheet 51 of paper. The printed sheet 51 of paper is carried by the carrying mechanism 253 to the paper ejection port 256 and ejected to the outside of the printer 2.

3. Image Pickup Printing System

An image pickup and printing system having the digital camera 1 and the printer 2 will now be described. With reference to FIGS. 8 to 11, three concrete examples of a method of connecting the digital camera 1 and the printer 2 in an image pickup and printing system 10 will be described. In the image pickup and printing system 10 of the preferred embodiment, any of the connecting methods may be employed.

3-1. Integration

FIG. 8 is a diagram showing the image pickup and printing system 10 in which the digital camera 1 and the printer 2 are physically directly connected to each other and integrated. In such a case, the digital camera 1 and the printer 2 can be integrally treated. Consequently, it is unnecessary to separately provide the printer 2, so that handling is easy.

Each of communication unit 13 of the digital camera 1 and the communication unit 23 of the printer 2 has a plurality of terminals in their physical connection portions. In the case of integrating both of the units, the plurality of terminals are electrically connected to each other, thereby enabling communication to be performed between the communication unit 13 of the digital camera 1 and the communication unit 23 of the printer 2.

In order to lock the physical connection between the digital camera 1 and the printer 2, the digital camera 1 and the printer 2 are provided with coupling members in portions indicated by reference characters A and B in FIG. 8. The left coupling member provided in the portion indicated by the reference character A and the right coupling member provided in the portion indicated by the reference character B are symmetrical with respect to the vertical line and have the same configuration.

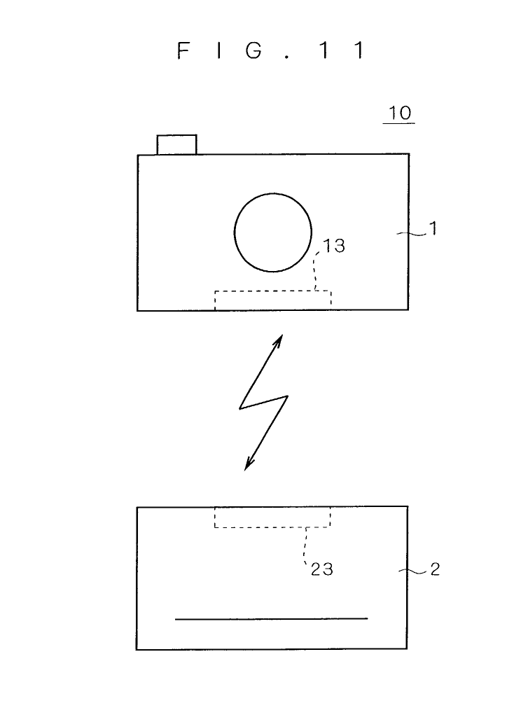

FIG. 9 is a diagram showing details of the left coupling member provided in the portion indicated by the reference character A in FIG. 8. As shown in FIG. 9, the digital camera 1 has a coupling notch 131 in a bottom face of the body cover, and the printer 2 has a coupling hook 231 disposed so that its upper end is projected from the body cover and a release button 232 for releasing connection. The sectional shape of the upper end of each of the coupling notch 131 and the coupling hook 231 is an almost L shape (which is bent to the right side in FIG. 9).

The center portion of the coupling hook 231 is pivotably attached to the body cover of the printer 2, the lower portion is pivotably attached to the release button 232, and the upper portion is energized to the right part of FIG. 9 by a spring 233.

At the time of coupling the digital camera 1 and the printer 2, the user pushes the coupling hook 231 into the coupling notch 131 while positioning them. The upper end of the coupling hook 231 enters the coupling notch 131 while moving to the left in the diagram along the shape of the coupling notch 131 to a predetermined position and, after that, moves to the right side by the force of the spring 233. By the above, the upper end of the coupling hook 231 and the coupling notch 131 engage with each other and are physically locked. In the right coupling member provided in the position indicated by the reference character B in FIG. 8, the upper end of the coupling hook and the coupling notch engage with each other and are physically locked, thereby integrally coupling the digital camera 1 and the printer 2 to each other.

In the case of separating the digital camera 1 and the printer 2 from each other, the release button 232 is depressed. By the operation, the upper end of the coupling hook 231 moves against the energizing power of the spring 233 to unlock the coupling notch 131 and the coupling hook 231, and the digital camera 1 and the printer 2 can be separated from each other.

3-2. Cable Connection

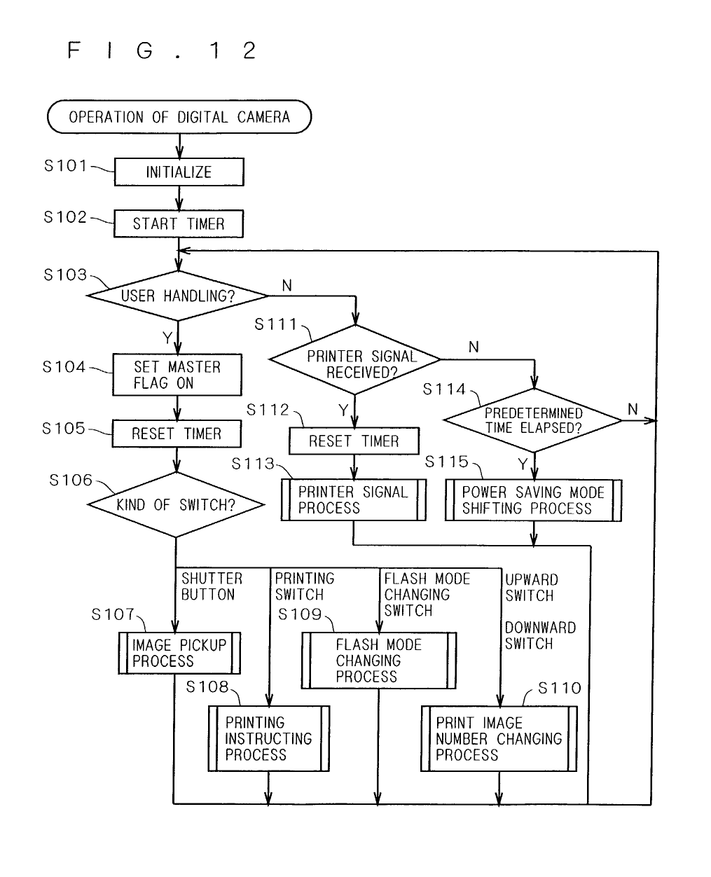

FIG. 10 is a diagram showing the image pickup and printing system 10 in the case where the digital camera 1 and the printer 2 are connected to each other via a transmission cable 3. In such a case, by employing a general transmission cable as the transmission cable 3, the manufacturing cost of the digital camera 1 and the printer 2 can be reduced.

Each of the communication unit 13 of the digital camera 1 and the communication unit 23 of the printer 2 has a connector-shaped terminal to which the transmission cable 3 can be attached on its outer side. By connecting the transmission cable 3 to the terminals of both of the devices, the terminals are electrically connected, so that communication can be performed between the communication unit 13 of the digital camera 1 and the communication unit 23 of the printer 2.

3-3. Wireless Communication

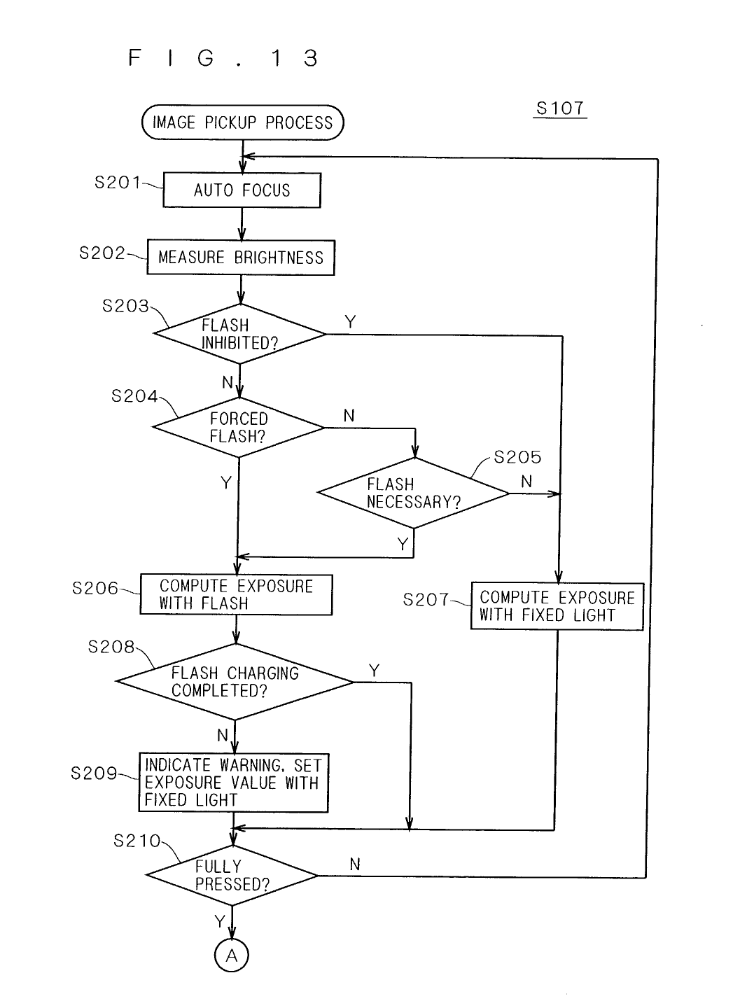

FIG. 11 is a diagram showing the image pickup and printing system 10 in the case where wireless communication can be performed between the digital camera 1 and the printer 2. In such a case, the transmission cable or the like is unnecessary, the flexibility of the disposing relation between the digital camera 1 and the printer 2 is increased so that the digital camera 1 and printer 2 can be more easily handled.

Each of the communication unit 13 of the digital camera 1 and the communication unit 23 of the printer 2 is a communication interface conformed with a wireless communication standard such as the infrared communication standard or Bluetooth (R) standard. By prestoring the communication address peculiar to the other device in each of the devices, communication between the communication unit 13 of the digital camera 1 and the communication unit 23 of the printer 2 can be performed.

4. Operation of Image Pickup Printing System

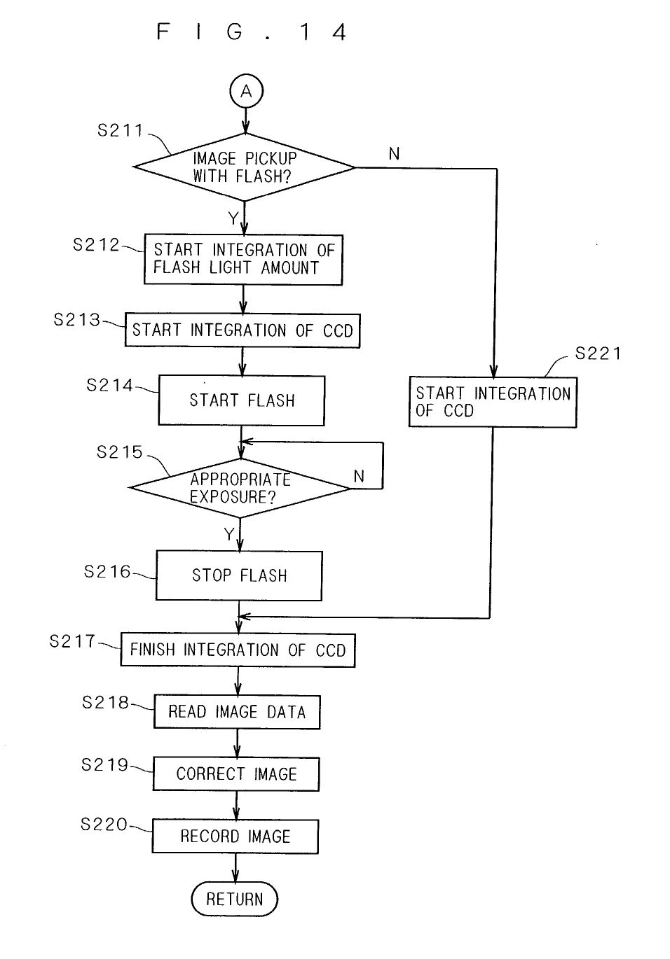

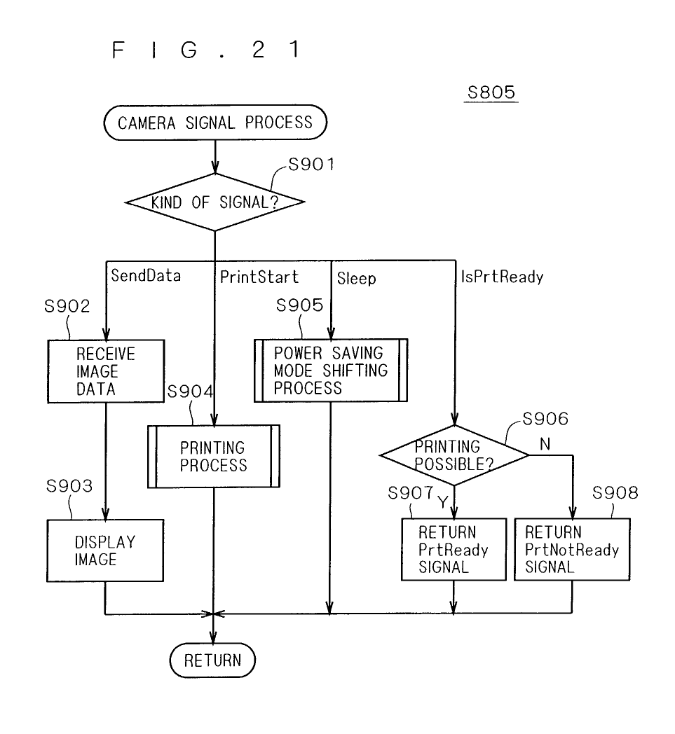

The operation of the image pickup and printing system 10 constructed as described above will now be described with reference to flowcharts of FIGS. 12 to 24. The flowcharts of FIGS. 12 to 19 show operations of the digital camera 1, and the flowcharts of FIGS. 20 to 24 show operations of the printer 2.

4-1. Operation of Digital Camera

First, the operation of the digital camera 1 will be described. FIG. 12 is a flowchart showing a basic operation of the digital camera 1. The power of the digital camera 1 is turned on by depressing the power supply switch 19m, and the digital camera 1 executes a series of operations shown in FIG. 12.

First, a necessary initializing process such as initialization of a variable is performed (step S101) and, to count predetermined time to shift to the power saving mode, the timer 101 is started (step S102). After that, which one of the shutter button 19s and the switch group 190 is ON or not, that is, whether any user handling is performed or not is determined (step S103).

In the case where the user handling is performed, a master flag as an internal flag indicating of a master-side device is set ON (step S104). In the image pickup and printing system 10 of the preferred embodiment, also in a process of printing or the like which requires link of the digital camera 1 and the printer 2, by handling one of them, both of the devices can be operated. Therefore, since the user handles one of the devices, in the image pickup and printing system 10, the device handled by the user is defined as a master-side device, and the device which is not handled is defined as a slave-side device, thereby distinguishing the devices from each other.

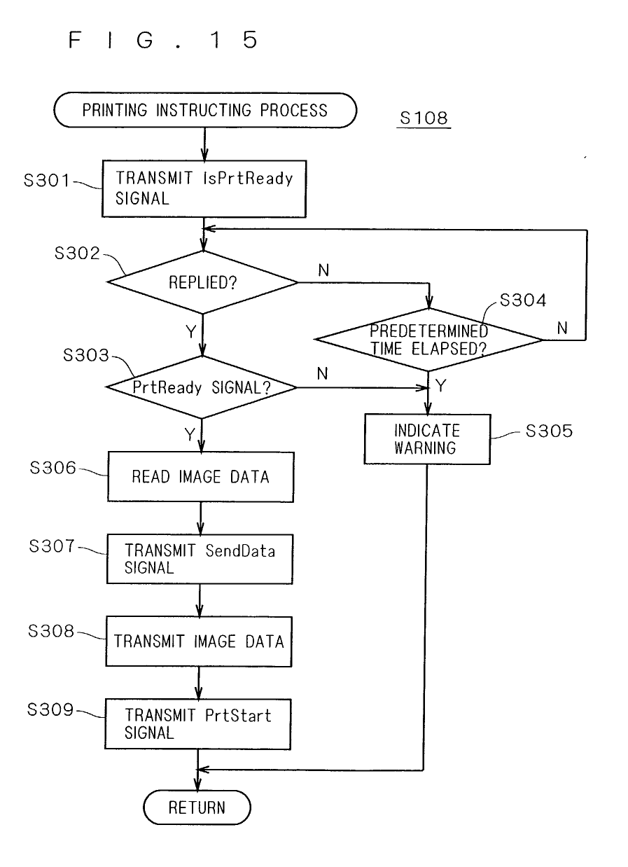

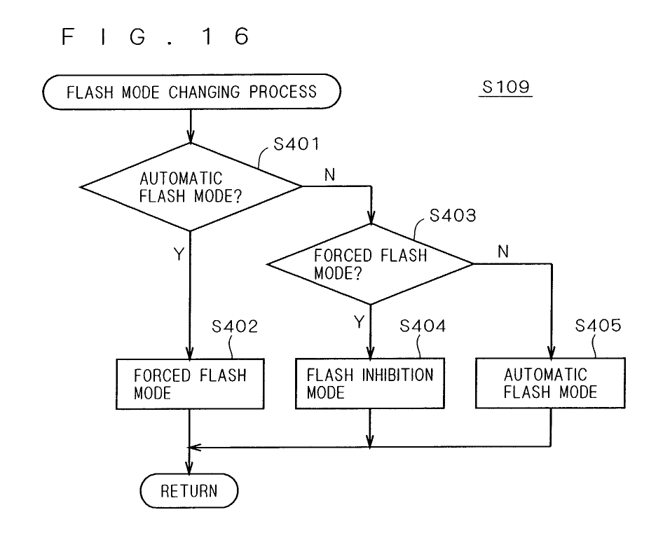

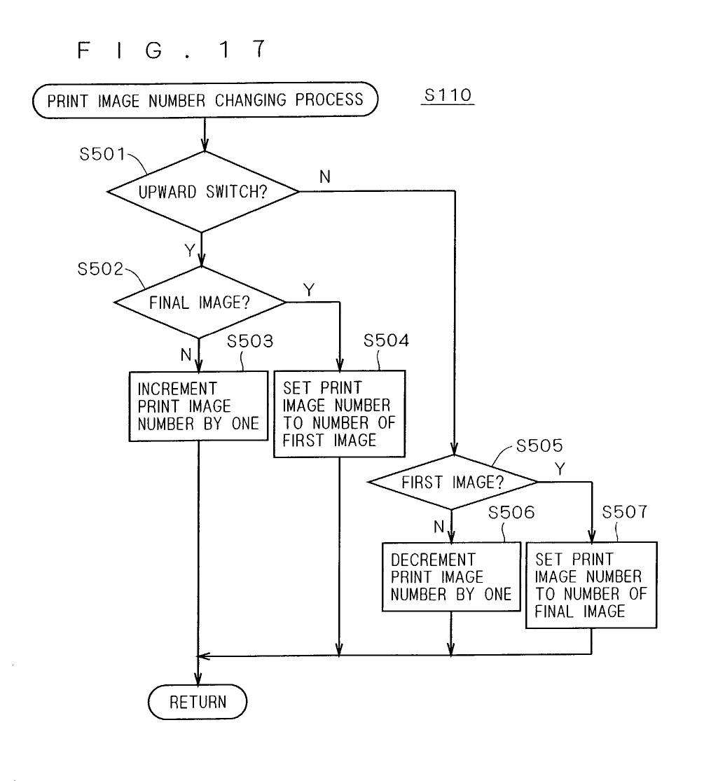

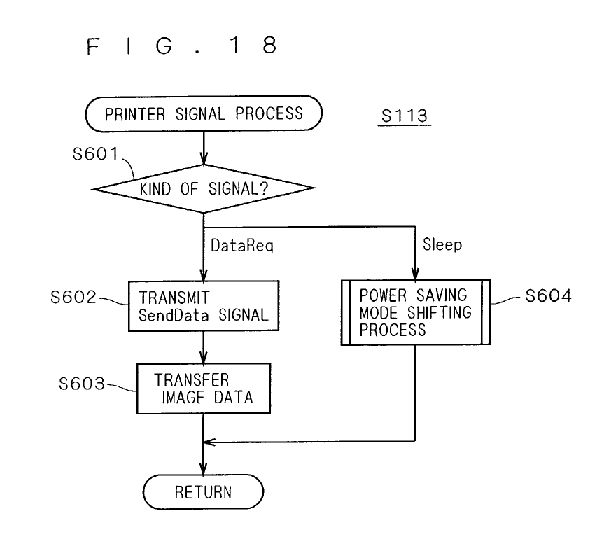

Next, elapsed time counted by the timer 101 is reset to 0 (step S105). The kind of the switch handled is determined (step S106), and a process according to the kind of the switch is performed. Specifically, when the kind of the switch is the shutter button 19s, an image pickup process of step S107 (operations in FIGS. 13 and 14 which will be described later) is performed. In the case of the printing switch 19p, a printing instructing process (operation of FIG. 15 which will be described later) in step S108 is performed. In the case of the flash mode changing switch 19f, a flash mode changing process of step S109 (operation of FIG. 16 which will be described later) is performed. In the case of the upward switch 19U or downward switch 19D, a print image number changing process in step S110 (operation in FIG. 17 which will be described later) is performed. After completion of the processes in steps S107 to S110, the process returns to step S103 where whether the user handling is performed or not is determined again.

In step S103, when all of the switches are OFF, that is, when the user handling is not performed, whether a signal from the printer 2 is received or not is determined (step S111).

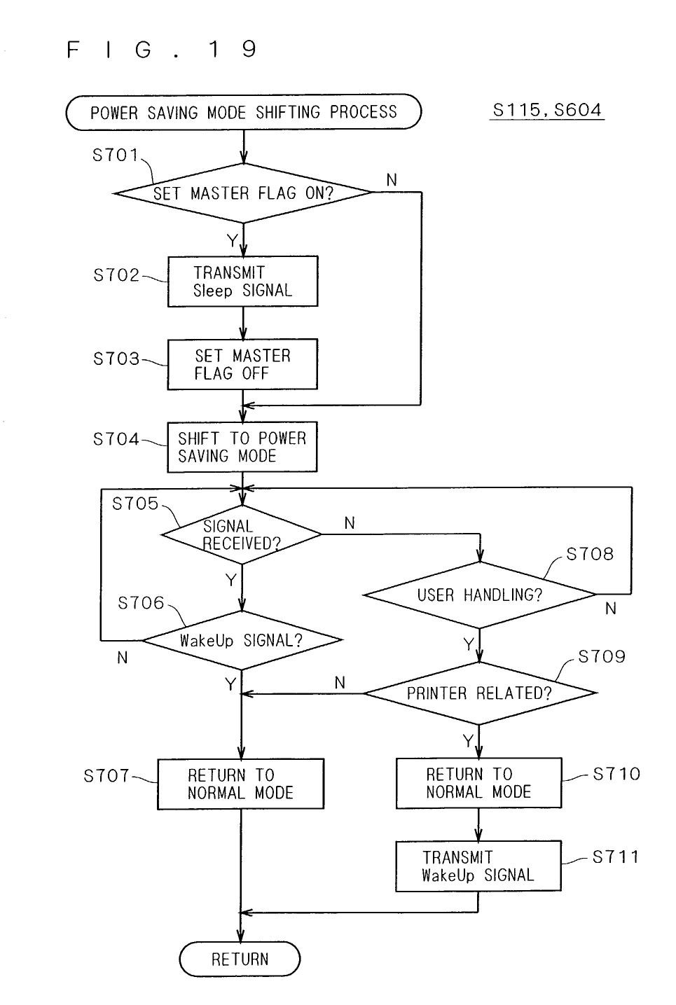

In the case where a signal from the printer 2 is received, after the elapsed time counted by the timer 101 is reset to 0 (step S112), a printer signal process (operation in FIG. 18 which will be described later) is performed (step S113). When the process is finished, the process returns to step S103 where whether the user handling is performed or not is determined again.

On the other hand, when there is no signal from the printer 2, whether the elapsed time counted by the timer 101 is equal to or longer than the predetermined time or not is determined (step S114).

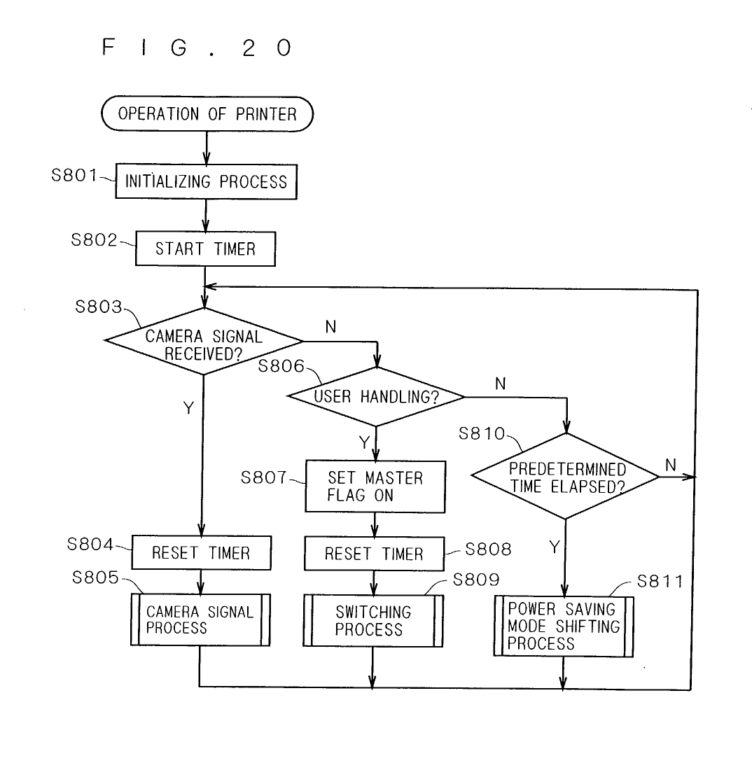

When the predetermined time or longer has elapsed, the power saving mode shifting process (operation of FIG. 19 which will be described later) is performed (step S115). When the predetermined time has not elapsed yet, the process returns to step S103 and whether the user handling is performed or not is determined again.

4-1-1. Image Pickup Process of Digital Camera

With reference to the flowcharts of FIGS. 13 and 14, the details of the image pickup process (step S107 in FIG. 12) for obtaining image data of the subject by the digital camera 1 will be described.

First, an AF operation is performed so that focus is achieved on the subject (step S201) and the brightness of the subject is measured (step S202). Next, whether the flash mode is a flash inhibition mode or not is determined (step S203). In the case of the flash inhibition mode, the program advances to step S207. In the other cases, the program advances to step S204. Further, in step S204, whether the flash mode is a forced flash mode or an automatic flash mode is determined. In the case of the forced flash mode, the process advances to step S206. In the case of the automatic flash mode, the process advances to step S205.

In step S205, based on the measured brightness of the subject, whether emission of the flash 17 is necessary or not is determined. When the brightness of the subject is low and it is determined that the emission of the flash 17 is necessary, the process advances to step S206. When it is determined that the emission is unnecessary, the process advances to step S207.

In step S206, the f-number of the lens system 12 and integration time of the CCD 111 for image pickup with an emission of the flash 17 (hereinafter, referred to as “image pickup with flash”), are obtained and set as exposure conditions, and the process advances to step S208. On the other hand, in step S207, the f-number of the lens system 12 and the integration time of the CCD 111 for image pickup with fixed light are obtained by computation using the brightness and set as exposure conditions, and the process advances to step S210.

In step S208, whether charging of the flash 17 is completed or not is determined. When the charging is completed, the process advances to step S210. On the other hand, when the charging is not completed yet, the program advances to step S209 where the indication lamp 18b positioned at a side of the finder 15 blinks to warn the user of the state that the charging is not completed yet. If the exposure conditions for image pickup with flash are used as they are, exposure becomes severely insufficient. Consequently, the f-number and the integration time of the CCD 111 are changed to values appropriate for image pickup with fixed light at this time, and the exposure conditions are reset.

The operation necessary for image pickup is completed, and whether the shutter button 19s of the digital camera 1 is fully pressed or not is determined in step S210. When the shutter button 19s is not fully pressed, the process returns to step S201 and the series of operations are repeated. On the other hand, when the shutter button 19s is fully pressed, the process advances to step S211 (FIG. 14) to start the image pickup operation.

In step S211, whether image pickup is performed with a flash or not is determined. If “Yes”, the light control circuit 161 starts integrating reflection light of the flash light from the subject received by the light control sensor 16 (step S212). Further, the CCD 111 starts integration (exposure) (step S213), and the flash control circuit 171 makes the flash 17 emit the flash light toward the subject (step S214). The light control circuit 161 continues integration of an amount of light received by the light control sensor 16 until the amount reaches an appropriate exposure amount (step S215). At the time point when the amount reaches the appropriate exposure amount, the flash control circuit 171 stops emission of the flash 17 (step S216), and the CCD 111 finishes integration (step S217).

On the other hand, when the image pickup is not with a flash (in the case of image pickup with fixed light), the CCD 111 starts integration (exposure) (step S221). After elapse of the set integration time, the CCD 111 finishes integration (step S217).

When the CCD 111 finishes integration, a signal is read as image data from the CCD 111 (step S218), and a predetermined process is performed by the image correcting unit 113 (step S219). After that, a unique number is assigned to the processed image data, and the resultant is recorded to the memory card 9 (step S220).

4-1-2. Printing Instructing Process of Digital Camera

With reference to the flowchart of FIG. 15, the detail of the printing instructing process (step S108 in FIG. 12) of the digital camera 1 for instructing the printer 2 to perform printing will now be described.

First, the digital camera 1 transmits an IsPrtReady signal for inquiring the printer 2 of whether printing can be performed or not (step S301). As will be described later, if the printing is possible, the printer 2 returns a PrtReady signal. If the printing is not possible, the printer 2 returns a PrtNotReady signal.

The digital camera 1 waits for the signal returned from the printer 2 (step S302). When the signal is returned, the process advances to step S303. However, when the power of the printer 2 is not turned ON or when communication cannot be performed due to some fault, no signal is returned from the printer 2. Consequently, when there is no response for predetermined time (“Yes” in step S304), it is determined that the printing is impossible, the indication lamp 18b blinks to warn the user of the state where the printing is impossible (step S305), and the process is finished as it is.

Even in the case where a signal is returned from the printer 2, if the returned signal is not the PrtReady signal (“No” in step S303), the printing is impossible. Therefore, the indication lamp 18b similarly blinks to warn the user of the state where the printing is impossible (step S305), and the process is finished as it is.

On the other hand, in the case where the signal returned from the printer 2 is the PrtReady signal (“Yes” in step S303), printing is possible so that the process is continued. The image data of the number set as a printing target is read from the memory card 9 to the RAM 114. The number of image data to be printed (hereinafter, referred to as “printing image number”) is set in a printing image number changing process (operation of FIG. 17) which will be described later.

A SendData signal as a preparation signal for transmitting image data is transmitted to the printer 2 (step S307) and, subsequently, the image data read to the RAM 114 is transmitted to the printer 2 (step S308). When the transmission of the image data is completed, a PrintStart signal instructing start of printing is transmitted (step S309). Thereby, printing of the image data transmitted is started in the printer 2.

4-1-3. Flash Mode Changing Process of Digital Camera

With reference to the flowchart of FIG. 16, the detail of the flash mode changing process (step S109 in FIG. 12) of the digital camera 1 will be described.

First, whether the present flash mode is an automatic flash mode or not is determined (step S401). In the case of the automatic flash mode, the flash mode is changed to a forced flash mode (step S402).

In the case where the present flash mode is not the automatic flash mode, further, the present flash mode is a forced flash mode or not is determined (step S403). If “Yes”, the flash mode is changed to the flash inhibition mode (step S404). In the case where the present flash mode is not the forced flash mode, that is, in the case of the flash inhibition mode, the flash mode is changed to the automatic flash mode (step S405).

4-1-4. Print Image Number Changing Process of Digital Camera

With reference to the flowchart of FIG. 17, the detail of the print image number changing process (step S110 in FIG. 12) for changing the print image number of the digital camera 1 will be described.

First, whether a switch handled by the user is the upward switch 29U or the downward switch 29D is determined (step S501).

In the case where the handled switch is the upward switch 29U, whether the presently set print image number is the number of the final image data in the image data recorded in the memory card 9 or not is determined (step S502). In the case where the number is not the final image data number, the print image number is incremented (step S503). In the case of the final image data number, the print image number is changed and set to the number of the first image data in the image data recorded in the memory card 9 (step S504).

On the other hand, in the case where the handled switch is the downward switch 29D, whether the print image number presently set is the number of the first image data in the image data recorded in the memory card 9 or not is determined (step S505). In the case where the presently set print image number is not the number of the first image data, the print image number is decremented (step S506). In the case of the number of the final image data, the print image number is changed and set to the number of the final image data of the image data recorded on the memory card 9 (step S507).

4-1-5. Printer Signal Process of Digital Camera

With reference to the flowchart of FIG. 18, the detail of the printer signal process (step S113 in FIG. 12) that the digital camera 1 processes a signal received from the printer 2 will be described.

First, the kind of the signal received from the printer 2 is determined (step S601). When the received signal is a DataReq signal indicating that the printer 2 requests transmission of the image data, first, a SendData signal is transmitted from the digital camera 1 to the printer 2 (step S602). Further, the requested image data is read from the memory card 9 and transmitted to the printer 2 (step S603).

On the other hand, when the received signal is a Sleep signal instructing shift from the normal mode to the power saving mode, the power saving mode shifting process (operation of FIG. 19) is performed (step S604).

4-1-6. Power Saving Mode Shifting Process of Digital Camera

With reference to the flowchart of FIG. 19, the detail of the power saving mode shifting process for shifting the digital camera 1 to the power saving mode (step S115 in FIG. 12 and step S604 in FIG. 18) will be described.

First, whether the master flag is set ON or not is determined (step S701). If the master flag is not set ON (in the case where the digital camera 1 is a slave-side device), the process advances to step S704.

On the other hand, when the master flag is set ON (when the digital camera 1 is the master-side device handled by the user), the Sleep signal instructing shift from the normal mode to the power saving mode is transmitted to the printer 2 as a slave-side device (step S702), and the master flag is set OFF (step S703). In the case where the digital camera 1 is the master-side device when the digital camera 1 shifts to the power saving mode, the Sleep signal is transmitted to the printer 2 as the slave-side device. Consequently, as will be described, the printer 2 can be simultaneously shifted to the power saving mode.

The Sleep signal is inputted as a power saving mode shifting instruction from the CPU 115 to the power supply control unit 141. In response to the Sleep signal, the power supply control unit 141 supplies power only to the minimum processing units necessary for a determination process for returning from the power saving mode to the normal mode (the following steps S705 to S709), and stops supply of the power to the other majority of processing units. Further, the CPU 115 reduces its clock speed. In such a manner, the digital camera 1 shifts to the power saving mode in which power consumption is suppressed (step S704).

When the digital camera 1 shifts to the power saving mode, the digital camera 1 waits for reception of a signal from the printer 2 or handling of the user (turn-on of any switch in the shutter button 19s and the switch group 190) (steps S705 and S708).

When the signal from the printer 2 is received in step S705, whether the received signal is a WakeUp signal instructing return from the power saving mode to the normal mode or not is determined (step S706). In the case where the signal is not the WakeUp signal, the process returns again to step S705 where the digital camera 1 waits for the signal from the printer 2 or user handling.

On the other hand, when the received signal is the WakeUp signal, the WakeUp signal is inputted as a normal mode return instruction from the CPU 115 to the power supply control unit 141. In response to the WakeUp signal, the power supply control unit 141 changes to supply the power to all of the processing units of the digital camera 1, and the CPU 115 switches its operation clock to a normal clock. It makes the digital camera 1 to return to the normal mode (step S707).

When there is the user handling in step S708, whether the handled switch is a switch related to the printer 2 or not is determined (step S709). The switch related to the printer 2 is a switch accepting an instruction of operation requiring the printer 2. In the preferred embodiment, the printing switch 19p accepting the instruction of causing the printer 2 to perform a printing process corresponds to the switch related to the printer 2.

In the case of the switch related to the printer 2, first, the WakeUp signal is inputted as the normal mode return instruction from the CPU 115 to the power supply control unit 141, and the digital camera 1 returns to the normal mode (step S710). Further, the WakeUp signal is also transmitted to the printer 2 (step S711). As will be described later, when the printer 2 is in the power saving mode, the printer 2 can return to the normal mode.

In the case of a switch which is not related to the printer 2, that is, a switch accepting an instruction of operation which can be completed by the digital camera 1, the process advances to step S707 where only a process of returning the digital camera 1 to the normal mode is performed, and a process of transmitting the WakeUp signal to the printer 2 is not performed.

As described above, in the case where the digital camera 1 returns to the normal mode by the user handling, if the operation instructed by the user handling is related to the printer 2, the WakeUp signal is transmitted to the printer 2. Consequently, even in the case where the printer 2 is in the power saving mode, the printer 2 can be returned to the normal mode without requiring a handling of returning the printer 2 to the normal mode.

When the operation can be completed by the digital camera 1, it is unnecessary to return the printer 2 to the normal mode. Consequently, the WakeUp signal is not transmitted to the printer 2, and the printer 2 remains in the power saving mode and power consumption can be effectively suppressed.

4-2. Operation of Printer

The operation on the printer side will now be described. FIG. 20 is a flowchart showing a basic operation of the printer 2. When the power supply switch 29m is depressed, the printer 2 is turned on and executes the series of operations shown in FIG. 20.

First, a necessary initializing process such as initialization of a variable is performed (step S801) and, to count predetermined time to shift to the power saving mode, the timer 201 is started (step S802).

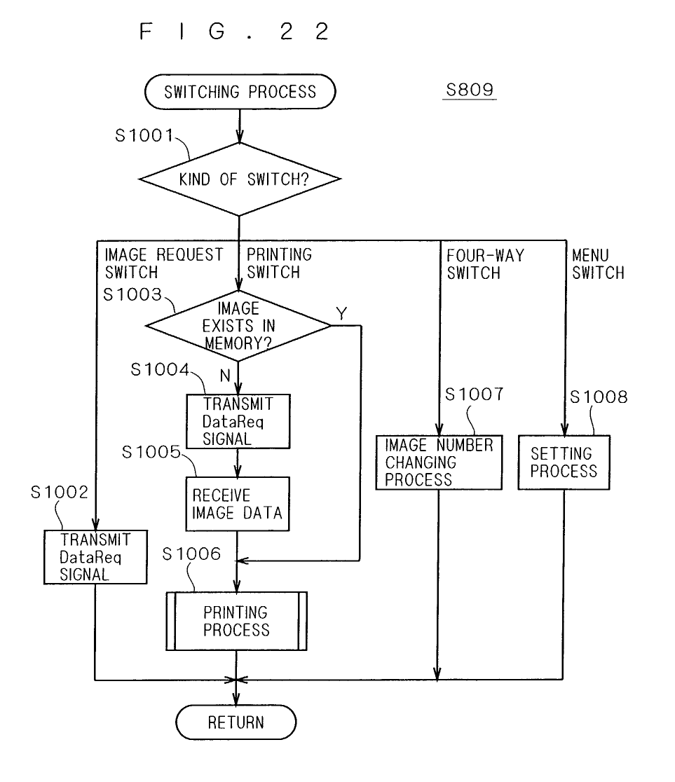

Subsequently, whether a signal from the digital camera 1 is received or not is determined (step S803). In the case where the signal is received, after the elapsed time counted by the timer 201 is reset to 0 (step S804), the camera signal process (operation of FIG. 21 which will be described later) is performed (step S805). After the process is finished, the process returns to step S803 where whether the signal from the digital camera 1 is received or not is determined again.

When there is no signal from the digital camera 1, whether any switch in the switch group 290 and the four-way switch 291 is ON or not is determined, that is, whether any user handling is performed or not is determined (step S806).

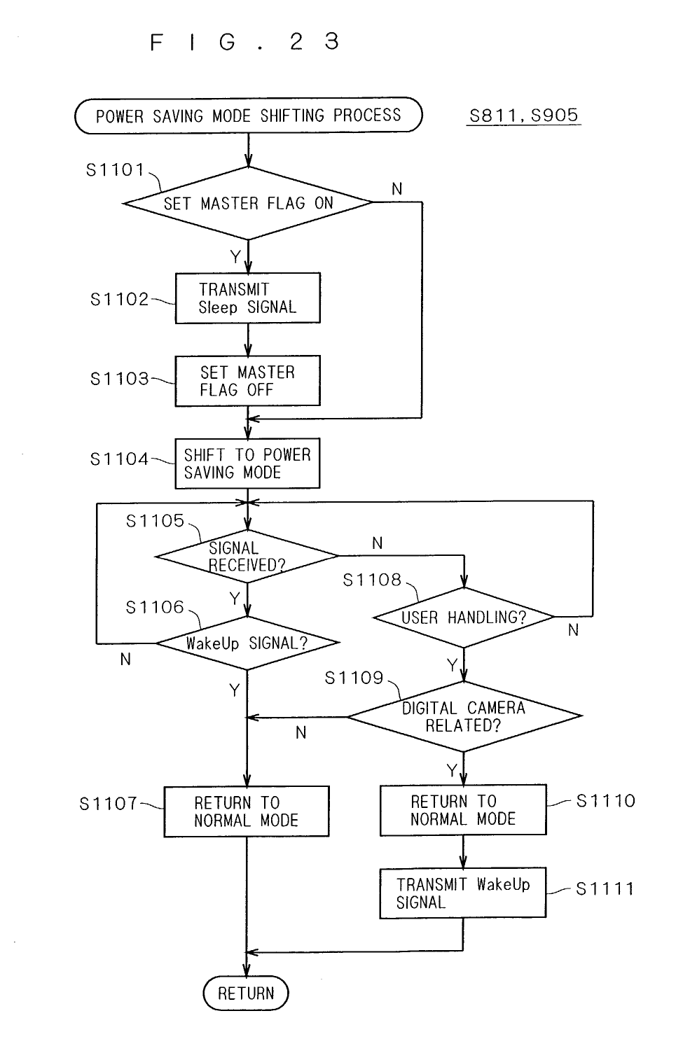

When the user handling is performed, the master flag as an internal flag indicative of the master-side device is set ON (step S807), and the elapsed time counted by the timer 201 is reset to 0 (step S808). Subsequently, the switching process (operation of FIG. 22 which will be described later) is performed (step S809), and the process is finished. After that, the process returns to step S803 and whether the signal from the digital camera 1 is received or not is determined again.

On the other hand, when all of the switches are turned OFF, that is, when the user handling is not performed, whether the elapsed time counted by the timer 201 is equal to or longer than the predetermined time or not is determined (step S810).

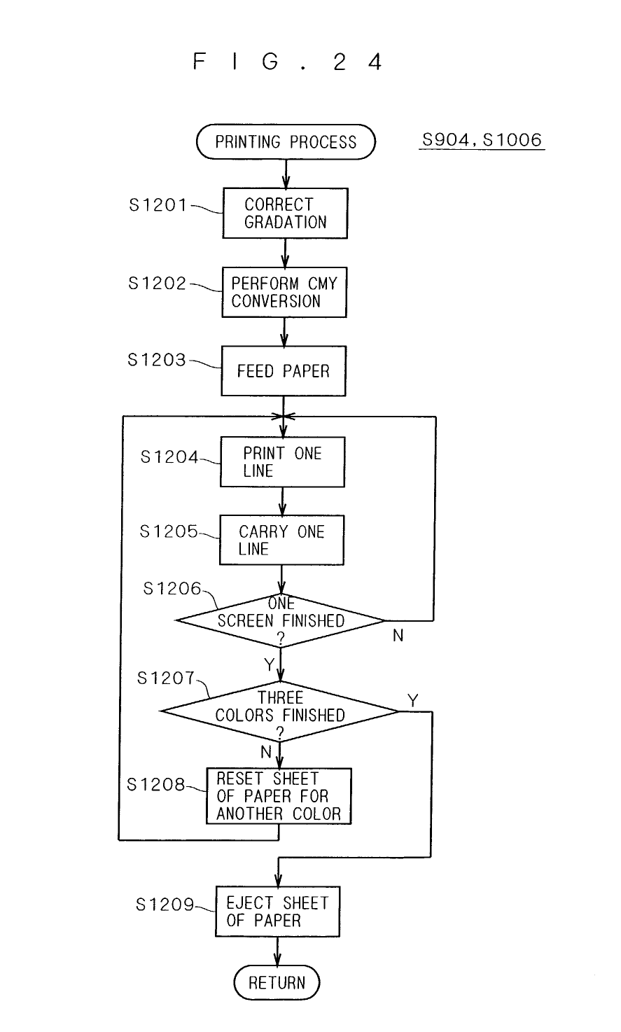

If the predetermined time or longer has elapsed, the power saving mode shifting process (operation of FIG. 23 which will be described later) is performed (step S811). If the predetermined time or longer has not elapsed, the process returns to step S803 and whether the signal from the digital camera 1 is received or not is determined again.

4-2-1. Camera Signal Process of Printer

With reference to the flowchart of FIG. 21, the detail of the camera signal process (step S805 in FIG. 20) for processing the signal received from the digital camera 1 by the printer 2 will be described.

First, the kind of the signal received from the digital camera 1 is determined (step S901). After that, operations according to the signal are performed (steps S902 to S908).

When the received signal is the SendData signal, image data transmitted subsequent to the signal from the digital camera 1 is received and stored into the RAM 214 (step S902). Further, the received image data is displayed on the display 28 (step S903).

When the received signal is the PrintStart signal, the printing process (operation of FIG. 24 which will be described later) is performed (step S904). When the received signal is the Sleep signal, the power saving mode shifting process (operation of FIG. 23 which will be described later) is performed (step S905).

When the received signal is an IsPrtReady signal, whether printing by the printing unit 25 can be performed or not is determined (step S906). In the state where printing can be performed, a PrtReady signal is transmitted to the digital camera 1 (step S907). In the state where printing is impossible due to short of the ink sheet 52 or the like, a PrtNotReady signal is transmitted to the digital camera 1 (step S908).

4-2-2. Switching Process of Printer

With reference to the flowchart of FIG. 22, the detail of the switching process (step S809 in FIG. 20) that the printer 2 performs a process according to the switch handled by the user will be described.

First, the kind of the switch handled is determined (step S1001). After that, the operation according to the kind of the switch is performed (steps S1002 to S1008).

When the handled switch is the image request switch 29q, a DataReq signal requesting the digital camera 1 to send image data is transmitted (step S1002).

In the case where the handled switch is the printing switch 29p, whether image data is stored in the RAM 214 or not is determined (step S1003). If it is stored, a printing process (operation of FIG. 24 which will be described later) is performed so as to print the image data (step S1006).

On the other hand, when the image data is not stored, the DataReq signal requesting the digital camera 1 to send image data is transmitted (step S1004). After the image data to be returned is received (step S1005), the printing process is performed (step S1006).

When the handled switch is any switch in the four-way switch 291, a process of changing the number of the image data to be printed or requested to be transmitted from the digital camera 1 is performed (step S1007). When the handled switch is the menu switch 29n, a menu screen is displayed on the display 28, and setting from the user is accepted (step S1008).

4-2-3. Power Saving Mode Shifting Process of Printer

With reference to the flowchart of FIG. 23, the detail of the power saving mode shifting process (step S811 in FIG. 20 and step S805 in FIG. 21) for shifting the printer 2 to the power saving mode will be described.

First, whether the master flag is set ON or not is determined (step S1101). When the master flag is not set ON (in the case where the printer 2 is a slave-side device), the process advances to step S1104.

On the other hand, when the master flag is set ON (in the case where the printer 2 is the master-side device which is handled by the user), the Sleep signal instructing shift from the normal mode to the power saving mode is transmitted to the digital camera 1 as the slave-side device (step S1102), and the master flag is set OFF (step S1103). As described above, when the printer 2 serving as the master-side device shifts to the power saving mode, the Sleep signal is transmitted to the digital camera 1 as the slave-side device, so that the digital camera 1 can be simultaneously shifted to the power saving mode.

As described above, when the Sleep signal is transmitted from the digital camera 1 to the printer 2, or when the Sleep signal is transmitted from the printer 2 to the digital camera 1, the Sleep signal is transmitted to the slave-side device only when the master-side device shifts to the power saving mode. In other words, when the slave-side device shifts to the power saving mode, the Sleep signal is not transmitted to the master-side device. Consequently, a problem such that the master-side device being handled by the user suddenly shifts to the power saving mode in association with the shift of the slave-side device to the power saving mode can be avoided.

Subsequently, the Sleep signal as the power saving mode shifting instruction is inputted from the CPU 215 to the power supply control unit 241. In response to the Sleep signal, the power supply control unit 241 supplies the power only to the minimum processing units necessary for determination of return from the power saving mode to the normal mode (steps S1105 to S1109) and stops supplying power to the other majority of processing units. Further, the CPU 215 reduces its operation clock speed. It makes the printer 2 to shift to the power saving mode in which power consumption is suppressed (step S1104).

When the printer 2 shifts to the power saving mode, the printer 2 waits for reception of the signal from the digital camera 1 or handling from the user (turn-on of any switch in the switch group 290 and the four-way switch 291) (steps S1105 and S1108).

When the signal from the digital camera 1 is received in step S1105, whether the received signal is the WakeUp signal instructing return from the power saving mode to the normal mode or not is determined (step S1106). In the case where the received signal is not the WakeUp signal, the process returns again to step S1105 where the printer 2 waits for the signal from the digital camera 1 or the user handling.

On the other hand, when the received signal is the WakeUp signal, the WakeUp signal as a normal mode return instruction is inputted from the CPU 215 to the power supply control unit 241. In response to the WakeUp signal, the power supply control unit 241 changes so as to supply power to all of the processing units in the printer 2 and the CPU 215 switches its operation clock to a normal clock. It makes the printer 2 to return to the normal mode (step S1107).

When there is user handling in step S1108, whether the handled switch is a switch related to the digital camera 1 or not is determined (step S1109). A switch related to the digital camera 1 denotes a switch accepting an instruction of operation requiring the digital camera 1. In the preferred embodiment, such switch corresponds to the image request switch 29q accepting an instruction of requesting the digital camera 1 to send image data or the printing switch 29p accepting an instruction of printing image data in the digital camera 1.

In the case of the switch related to the digital camera 1, first, the WakeUp signal is inputted as the normal mode return instruction from the CPU 215 to the power supply control unit 241, and the printer 2 returns to the normal mode (step S1110). Further, the WakeUp signal is transmitted to the digital camera 1 (step S1111). When the digital camera 1 is in the power saving mode, the digital camera 1 is returned to the normal mode.

On the other hand, in the case of a switch which is not related to the digital camera 1, that is, in the case of a switch accepting an instruction of operation which can be completed by the printer 2, the process advances to step S1107 where only operation of returning the printer 2 to the normal mode is performed and a process of transmitting the WakeUp signal to the digital camera 1 is not performed.

As described above, when the printer 2 returns to the normal mode by the user handling, if the operation instructed by the user handling is related to the digital camera 1, the WakeUp signal is transmitted to the digital camera 1. Consequently, even when the digital camera 1 is in the power saving mode, the digital camera 1 can be returned to the normal mode without requiring handling for returning the digital camera 1 to the normal mode.

Specifically, as described above, when both of the digital camera 1 and the printer 2 are in the power saving mode, by handling one of the digital camera 1 and the printer 2 so as to return from the power saving mode to the normal mode, the WakeUp signal is transmitted to the other device. By the operation, both of the devices return to the normal mode. This eliminates a need of a complicated handling of causing the devices to independently return to the normal mode.

When the operation can be completed by the printer 2, it is unnecessary to return the digital camera 1 to the normal mode. Consequently, the WakeUp signal is not transmitted to the digital camera 1 and the digital camera 1 remains in the power saving mode, so that the power consumption can be effectively suppressed.

4-2-4. Printing Process of Printer

With reference to the flowchart of FIG. 24, the detail of the printing process (step S904 in FIG. 21 and step S1006 in FIG. 22) executed by the printing unit 25 of the printer 2 will be described.

First, the gradation of image data stored in the RAM 214 is corrected by the printing control unit 251 (step S1201) and, further, RGB values of the image data are converted to CMY values (step S1202).

Next, feeding of paper is instructed from the printing control unit 251 to the carrying mechanism 253 of the printing unit 25, and the sheet 51 of paper is set in the predetermined printing start position (step S1203).

Print data of one line of one color is read from the image data stored in the RAM 214 and, on the basis of the print data, the print head 252 is heated. The ink of the ink sheet 52 is sublimated and one line of one color is printed on the sheet 51 of paper (step S1204). The sheet 51 of paper and the ink sheet 52 are carried by one line by the carrying mechanism 253 (step S1205).

The operations of steps S1204 and S1205 are repeated until printing of one image of one color is finished (step S1206). In the case where printing of three colors is not finished after printing of one image of one color is finished (“No” in step S1207), the sheet 51 of paper is carried by the carrying mechanism 253 in the opposite direction to the predetermined printing start position and is reset, and the color to be printed is changed (step S1208). The operations of steps S1204 and S1205 are repeated with the changed color to perform printing.

When printing of three colors is finished in step S1207, the sheet 51 of paper to which printing is completed is carried to the paper ejection port 256 and ejected to the outside of the printer 2 (step S1209).

5. Modifications

Although the description has been given that the digital camera 1 and the printer 2 of the foregoing preferred embodiment are returned from the power saving mode to the normal mode by handling any switch of the provided switch group, a dedicated switch for returning to the normal mode may be provided. In such a case as well, by handling the switch of one of the devices, the WakeUp signal is transmitted from the handled device to the other device, thereby enabling both of the devices to be returned to the normal mode.

Similarly, although the description has been given that the digital camera 1 and the printer 2 in the foregoing preferred embodiment are shifted to the power saving mode after elapse of predetermined time, a dedicated switch for shifting to the power saving mode may be provided. In such a case as well, by handling the switch of one of the devices, the Sleep signal is transmitted from the handled device (that is, the master-side device) to the other device (that is, the slave-side device), thereby enabling both of the devices to be shifted to the power saving mode.

Although the printer 2 in the foregoing preferred embodiment has been described as a printer of a sublimation heat transfer type, a printer of any type such as an ink jet type or a dissolution heat transfer type may be used.

All or a part of the functions realized by performing computation by the CPU in accordance with a program in the foregoing preferred embodiment may be realized by a dedicated electric circuit.

While the invention has been shown and described in detail, the foregoing description is in all aspects illustrative and not restrictive. It is therefore understood that numerous modifications and variations can be devised without departing from the scope of the invention.

What is claimed is:

1. An image pickup and printing system comprising a digital camera and a printer as devices which can communicate with each other, wherein
each of said digital camera and said printer includes:
a power controller capable of switching a self device of said devices between a normal mode and a power saving mode; and
a signal generator for generating a first control signal in response to a user handling of said self device and supplying said first control signal to said power controller of said self device and said power controller of the other device of said devices, and
said power controller of each of said digital camera and said printer causes said self device to return from said power saving mode to said normal mode irrespective of whether said first control signal is supplied from said self device or said other device.

2. The image pickup and printing system according to claim 1, wherein
said signal generator transmits said first control signal to said other device only when an operation instructed by said user handling of said self device requires an operation of said other device.

3. The image pickup and printing system according to claim 1, wherein
each of said digital camera and said printer further includes
a register for registering said self device as a device to be handled in response to occurrence of said user handling of said self device, and
said power controller of each of said digital camera and said printer causes said self device to shift from said normal mode to said power saving mode in response to a second control signal generated in said device to be handled.

4. The image pickup and printing system according to claim 1, wherein
said power saving mode includes a state in which power which is sufficient to perform a determination process of determining whether or not to return to said normal mode, and is insufficient to perform an image pickup process or a printing process is supplied.

5. The image pickup and printing system according to claim 1, wherein
each of said digital camera and said printer further includes
an operation controller for controlling an operation of said self device, and
said power saving mode includes a state in which a clock speed of said operation controller is lower than that in said normal mode.

6. A digital camera which can communicate with a printer, including:
a power controller for causing said digital camera to return from a power saving mode to a normal mode in response to both of a user handling of said digital camera and reception of a predetermined control signal from said printer; and
a first transmitter for transmitting a first control signal instructing said printer to return from said power saving mode to said normal mode, to said printer in response to said user handling.

7. The digital camera according to claim 6, wherein
said first transmitter transmits said first control signal to said printer only when an operation instructed by said user handling requires an operation of said printer.

8. The digital camera according to claim 7, wherein
said operation of said printer required includes a printing process of said printer.

9. The digital camera according to claim 6, further including:
a register for registering said digital camera as a device to be handled in response to occurrence of said user handling of said digital camera; and
a second transmitter for transmitting a second control signal instructing said printer to shift from said normal mode to said power saving mode, to said printer at the time of shifting said digital camera from said normal mode to said power saving mode, when said digital camera is registered as said device to be handled.

10. The digital camera according to claim 6, wherein
said power saving mode includes a state in which power which is sufficient to perform a determination process of determining whether or not to return to said normal mode, and is insufficient to perform an image pickup process or a printing process is supplied.

11. The digital camera according to claim 6, further including
an operation controller for controlling an operation of said digital camera, wherein
said power saving mode includes a state in which a clock speed of said operation controller is lower than that in said normal mode.

12. A printer which can communicate with a digital camera, including:
a power controller for making said printer to return from a power saving mode to a normal mode in response to both of a user handling of said printer and reception of a predetermined control signal from said digital camera; and
a first transmitter for transmitting a first control signal instructing said digital camera to return from said power saving mode to said normal mode, to said digital camera in response to said user handling.

13. The printer according to claim 12, wherein
said first transmitter transmits said first control signal to said digital camera only when an operation instructed by said user handling requires an operation of said digital camera.

14. The printer according to claim 13, wherein
said operation of said digital camera required includes transmission of an image data by said digital camera.

15. The printer according to claim 12, further including:
a register for registering said printer as a device to be handled in response to occurrence of said user handling of said printer; and
a second transmitter for transmitting a second control signal instructing said digital camera to shift from said normal mode to said power saving mode, to said digital camera at the time of shifting said printer from said normal mode to said power saving mode, when said printer is registered as said device to be handled.

16. The printer according to claim 12, wherein
said power saving mode includes a state in which power which is sufficient to perform a determination process of determining whether or not to return to said normal mode, and is insufficient to perform an image pickup process or a printing process is supplied.

17. The printer according to claim 12, further including
an operation controller for controlling an operation of said printer, wherein
said power saving mode includes a state in which a clock speed of said operation controller is lower than that in said normal mode.
